(19) United States
(12) Patent Application Publication
(10) Pub. No.: US 2022/0276634 A1
(43) Pub. Date: Sep. 1, 2022

(54) PROTECTIVE STRUCTURES

(71) Applicant: Hewlett-Packard Development Company, L.P., Spring, TX (US)

(72) Inventors: Wei Huang, Palo Alto, CA (US); Gary J. Dispoto, Palo Alto, CA (US); Guy Adams, Bristol (GB)

(73) Assignee: Hewlett-Packard Development Company, L.P., Spring, TX (US)

(21) Appl. No.: 17/640,995

(22) PCT Filed: Oct. 23, 2019
(86) PCT No.: PCT/US2019/057525

§ 371 Date: Mar. 7, 2022

(51) Int. Cl. G05B 19/4099

(52) U.S. Cl. CPC G05B 19/4099; G05B 2219/49023

(57) ABSTRACT

Examples described herein relate to a system consistent with the disclosure. For instance, the system may comprise an additive manufacturing device including hardware to form a three-dimensional (3D) model, a memory resource, and a processing resource to receive data related to the 3D model, modify the data related to the 3D model to include a protective structure connected to the 3D model by a fusion bond, and dispense, based on the modified data, a printing agent onto build material layers to produce the 3D model and the protective structure around a portion of the 3D model.

### BACKGROUND

Additive manufacturing machines produce three-dimensional (3D) models by building up layers of material, Some 3D printing techniques are considered additive processes because they involve the application of successive layers of material. Some additive manufacturing machines are commonly referred to as “3D printing devices.” 3D printing devices and other additive manufacturing machines make it possible to convert a computer aided design (CAD) model or other digital representation of an object into a physical object.

### BRIEF DESCRIPTION OF THE DRAWINGS

FIG. 1 illustrates an example of a system consistent with the disclosure,

FIG. 2 illustrates an example of an apparatus suitable with a system consistent with the disclosure.

FIG. 3 illustrates an example of a method consistent with the disclosure.

FIG. 4 illustrates an example diagram of a non-transitory machine readable medium suitable with a system consistent with the disclosure.

FIG. 5 illustrates an example of a three-dimensional model fused to protective structures consistent with the disclosure.

FIG. 6 illustrates an example of a system consistent with the disclosure.

### DETAILED DESCRIPTION

Systems and methods described herein may form three-dimensional (3D) models by dispensing printing agent onto build material layers. The system may be a printing device that receives data to form the 3D model. The system may form a protective structure around the 3D model while forming the 3D model. As used herein, “printing device” refers to a hardware device that can physically produce representation(s) of text, images, models, etc. on a physical print medium and/or produce a three-dimensional model.

Printing devices, such as additive manufacturing devices may form 3D models and protective structures when a print job is received. The protective structure may assist during various post processing activities. The protective structure may limit the movement of the 3D model and provide protection for the 3D model (e.g., cushioning). Some printing devices form a protective structure around an entire 3D model during the printing process. In addition, some printing devices connect the protective structure to other structures (e.g., other protective structures and/or additional structures attached to the 3D model).

However, forming a protective structure around the entire 3D model may increase the cost of producing the 3D model due to the increased amount of material used to produce the 3D model and the protective structure that surrounds the entire 3D model, as compared to 3D models that do not have a protective structure surrounding the entire 3D model, Further, printing a 3D model with a protective structure surrounding the entire 3D model may increase the size of the printed 3D model due to the added layer of material (e.g., the protective structure), as compared to a 3D model that does not have a protective structure surrounding the entire 3D model. In addition, connecting the protective structure of a 3D model to other structures may cause the printing device to use extra material when connecting the features thereby increasing the cost of producing the 3D model, increasing the size of the 3D model, and making the 3D model difficult to handle because of the increased size.

As such, the disclosure relates to protective structures, as described herein. For example, a system may comprise an additive manufacturing device including hardware to form a three-dimensional (3D) model, a memory resource, and a processing resource to receive data related to the 3D model, modify the data to include a protective structure fused to the 3D model, and produce a 3D model and a protective structure around a portion of the 3D model. As used herein, “portion” refers to a part and/or piece of an object that is less than the whole and/or entire object.

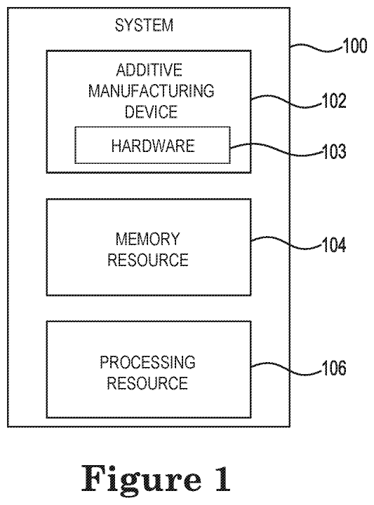

FIG. 1 illustrates an example of a system 100 consistent with the disclosure. The system 100 may be implemented in a variety of printing devices, such as an additive manufacturing device 102. For example, the additive manufacturing device 102 may be a Multi-jet Fusion (MJF), Fused Filament, Stereolithography (SLA), Selective Laser Sintering (SLS), Selective Laser Melting (SLM), Laser Pro Fusion, and 3D Binder Jetting. In some examples, the additive manufacturing device 102 may include hardware 103 to form a 3D model and a protective structure. The additive manufacturing device 102 may utilize the hardware 103 to deposit printing agent onto build material layers to form a 3D model and a protective structure. In some examples, the additive manufacturing device 102 may utilize the hardware 103 to deposit a plurality of printing agents onto build material layers.

In some examples, the system 100 may include a memory resource 104 to store information related to a print job. As used herein, “print job” refers to signals or states, which may be stored in a file and/or a set of files, usable to instruct a printing device in forming text, images, and/or models. The memory resource 104 may store information in the form of data related to a 3D model. In some examples, the data may assist the additive manufacturing device 102 when forming the 3D model and/or protective structure. For instance, the system 100 may receive data from a host device (e.g., computing device) and store the received data in the memory resource 104. The processing resource 106 may modify the received data and cause the hardware 103 of the additive manufacturing device 102 to carry out a print job relating to a 3D model and/or a protective structure. As used here in “data” refers to information related to the forming of a 3D model, for example, the size, shape, position, orientation, color of each part of the 3D model and/or information related to the forming of a 3D model and a protective structure, for example, the size, shape, position, orientation, color of each part of the 3D model and protective structure.

For instance, the processing resource 106 may be communicatively coupled to a host device. As used herein, “communicatively coupled” refers to various wired and/or wireless connections between devices such that data and/or signals may be transferred in various directions between the devices. A host device may send data relating to a 3D model to perform a print job from a system 100. The processing resource 106 of the system 100 may receive the data including instructions to print a 3D model. The processing resource 106 may analyze the received data to determine portions of the 3D model to include a protective structure around (e.g., portions smaller than the whole of the 3D model). That is, the processing resource 106 may analyze the 3D model for portions that may use added protection. For instance, the processing resource 106 may identify fragile regions of the 3D model and/or marks on the 3D model and determine if the fragile region and marks can use added protection. As used herein, “fragile region” refers to a region of an object that is not sturdy and/or easily broken or damaged. For example, the fragile region may be a portion of the 3D model that is easily damaged because it has a given width, thickness, or other dimension that is less than a corresponding dimension taken at another more sturdy region of the 3D model. As used herein, “mark” refers to a figure, symbol, or lines used as an indication of something.

In some examples, the processing resource 106 may modify the received data to include a protective structure around identified portions of the 3D model. For instance, the processing resource 106 may modify the received data to include instructions related to a 3D model and a protective structure. The modified data may cause the hardware 103 of the additive manufacturing device 102 to form a 3D model including a protective structure around an identified portion of the 3D model. The processing resource 106 may store the modified data in the memory resource 104 before performing a print job.

In some examples, the processing resource 106 may use the modified data to form a 3D model including a protective structure around identified portions of the 3D model by dispensing a printing agent onto build material layers. The modified data may include instructions related to printing (e.g., forming) the 3D model and the protective structure. The processing resource 106 may use the information in the modified data to form the 3D model and the protective structure by repeatedly dispensing printing agent on to build material layers.

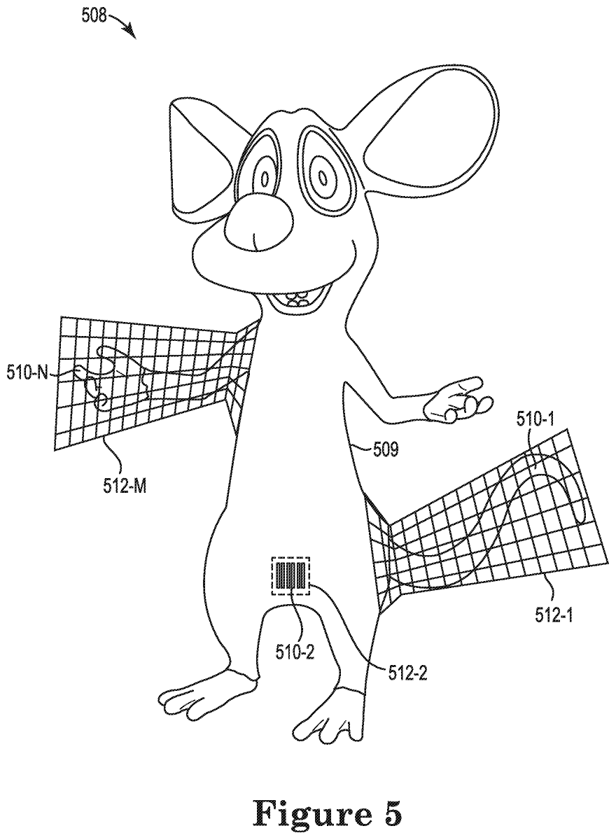

In some examples, the modified data may form a protective structure around a portion of a 3D model. That is, the protective structure may surround a portion of the 3D model to protect the portion from damage. The protective structure may cover the portion on all sides to limit the amount of force that is exerted on the portion. As used herein, “force” refers to pressure or energy exerted on an object as an attribute of physical action and/or movement. For example, the force may be from a chemical agent, solvent, and/or liquid being sprayed on a 3D model, air blowing onto a 3D model, a 3D model falling to the ground, among other possibilities. In some examples, the portion of the 3D model may be a fragile region of the 3D model. That is, the portion of the 3D model may be a section of the 3D model that may be easily damaged during post processing, handling, shipping, or movement of the 3D model. For example, the portion of the 3D model may be a tail of a mouse that may easily break during post processing, as illustrated in FIG. 5. However, this disclosure is not so limited.

For example, the portion of the 3D model may be other sections of a 3D model that may use added protection when a force is exerted on the 3D model. The portion may be a mark on the 3D model used for authentication and/or identification purposes. For instance, the portion may be an authentication mark, an identification mark, and/or a fiducial mark used to authenticate and identify a geographical region, a product, an owner, etc. In some examples, the mark (and/or fragile region) may be eroded by post processing. The protective structure may surround a mark (and/or fragile region) and prevent the mark (and/or fragile region) from being eroded during post processing such as sandblasting or other type of post processing. That is, after post processing the mark may be undamaged and used for authentication and/or identification.

In some examples, the processing resource 106 may cause the protective structure to surround a portion of the 3D model so that the portion of the 3D model is caged inside of the protective structure. Said differently, the processing resource 106 may cause the portion of the 3D model to be entirely encased inside the protective structure, as illustrated in FIG. 5. As used herein, “cage” refers to a structure with or without openings used to confine an object. In some examples, the processing resource 106 may cause the protective structure to conform to the shape of the portion of the 3D model. That is, the shape of the protective structure may follow the same shape of the portion of the 3D model. However, this disclosure is not so limited. For example, the processing resource 106 may cause the protective structure to form a box like structure (e.g., a standard shape to cage the portion) around the portion of the 3D model to surround (e.g., cage, encase) the portion of the 3D model. As used herein, “encase” refers to the act of enclosing an object and/or covering all sides of an object.

In some examples, the processing resource 106 may position the protective structure a distance away from the portion of the 3D model. That is, the protective structure may not come in direct contact with the portion of the 3D model. The processing resource 106 may cause the protective structure to fuse to the body of the 3D model and not the portion of the 3D model. The processing resource 106 may cause the protective structure to form a fusion bond with the body of the 3D model while creating a space between the portion of the 3D model and the protective structure. The protective structure may surround the portion of the 3D model without contacting the portion of the 3D model by forming a fusion bond with the protective structure and the body of the 3D model. However, this disclosure is not so limited.

For example, the protective structure may come in contact with the portion of the 3D model. That is, the processing resource 106 may cause the protective structure to fuse to the portion of the 3D model to provide protection to the portion. The protective structure may form a fusion bond with the portion of the 3D model. In some examples, the protective structure may form a fusion bond with the portion of the 3D model and the body of the 3D model to provide protection to the portion, That is, the protective structure may be fuse to both the body and the portion of the 3D model.

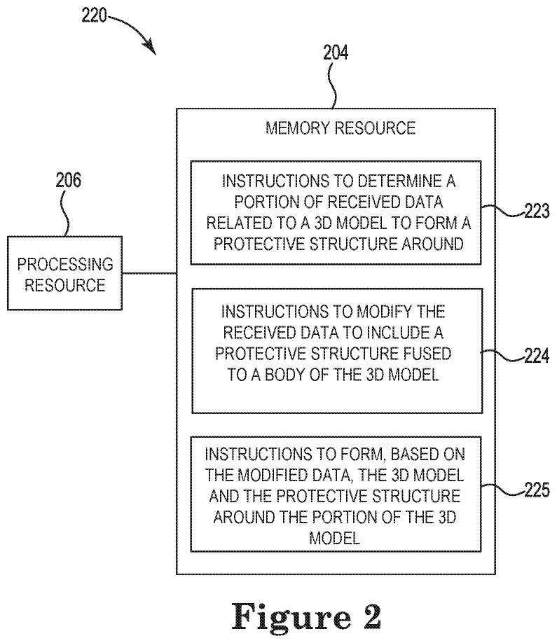

FIG. 2 illustrates an example of an apparatus 220 suitable with a system consistent with the disclosure. As illustrated in FIG. 2, the apparatus 220 includes a processing resource 206 and a memory resource 204, The processing resource 206 may be a hardware processing unit such as a microprocessor, application specific instruction set processor, coprocessor, network processor, or similar hardware circuitry that may cause machine-readable instructions to be executed. In some examples, the processing resource 206 may be a plurality of hardware processing units that may cause machine-readable instructions to be executed, The processing resource 206 may include central processing units (CPUs) among other types of processing units. The processing resource 206 may also include dedicated circuits and/or state machines, such as in an Application Specific Integrated Circuit (ASIC), Field Programmable Gate Array (FPGA) or similar design-specific hardware. The memory resource 204 may be any type of volatile or non-volatile memory or storage, such as random-access memory (RAM), flash memory, read-only memory (ROM), storage volumes, a hard disk, or a combination thereof.

The memory resource 204 may store instructions thereon, such as instructions 223, 224, 225, and 226. When executed by the processing resource 206, the instructions may cause the apparatus 220 to perform specific tasks and/or functions. For example, the memory resource 204 may store instructions 223 to determine a portion of received data related to a 3D model to form a protective structure around. The processing resource 206 may receive data related to a 3D model from a host device (e.g., computing device). In some examples, the processing resource 206 may store the received data in the memory resource 204. The processing resource 206 may then analyze the data to determine fragile regions of the 3D model and/or marks on the 3D model. In some examples, the processing resource 206 may identify the fragile regions and/or the marks as portions of the 3D model to form protective structures around. That is, the processing resource 206 may identify portions of the 3D model that may use additional protection during post processing, handling, shipping, or movement of the 3D model and determine that the portions can use a protective structure. In some examples, determining portions of the 3D model to form protective structures around may prevent the 3D model form damaging when a force (e.g., forces caused by port processing activities) is exerted onto the 3D model or a portion of the 3D model.

The memory resource 204 may store instructions 224 which may be executed by the processing resource 206 to modify the received data to include a protective structure fused to a body of the 3D model. The protective structure may be connected to a body of the 3D model by a fusion bond. In some examples, the processing resource 206 may convert the received data related to a 3D model into data related to 3D model including a protective structure by modifying the received data. The processing resource 206 may modify the received data by including a protective structure around fragile regions of the 3D model and/or marks on the 3D model (e.g., portions of the 3D model). However, this disclosure is not so limited. In some examples, the processing resource 206 may receive data relating to a 3D model including a protective structure from a host device, For instance, the processing resource 206 may receive data including instructions to form a 3D model and a connected protective structure. It should be understood that when an element is referred to as being “in contact,” or “connected to,” another element, it may be in contact, or connected, with the other element or intervening elements may be present. In contrast, when an object is “directly in contact with” or “directly connected to” another element it is understood that are no intervening elements (adhesives, screws, other elements) etc.

The protective structure may be positioned a distance away from the portion of the 3D model. In some examples, fusing the protective structure to the body of the 3D model and positioning the protective structure a distance away from the portion of the 3D model may protect the portion from damaging during post processing and removal of the protective structure. That is, preventing the protective structure from contacting the portion of the 3D model may protect the portion from damage.

In some examples, the protective structures may be positioned a distance of from about 0 millimeters (mm) to about 10 mm away from the portion of the 3D model, including all ranges and values in between. In various examples, the protective structures may be positioned a distance of from about 0.02 mm to about 10 mm away from the portion of the 3D model, including all ranges and values in between. For instance, in some examples, the protective structures may be positioned about 0 mm to about 0.02 mm, 0.02 mm to about 0. 05 mm, 0.02 mm to about 0.1 mm, 0.02 mm to about 0.2 mm, 0.02 mm to about 0.5 mm, 0.02 mm to about 1,0 mm, 0.02 mm to about 2.0 mm, 0.02 mm to about 2.5 mm, 0.02 mm to about 4.0 mm, 0.02 mm to about 5.5 mm, 0.02 mm to about 7.0 mm, 0.02 mm to about 8.5 mm, 0.02 mm to about 10.0 mm, 8.75 mm to about 10.0 mm, 7.25 mm to about 10.0 mm, 6.75 mm to about 10.0 mm, 5.25 mm to about 10,0 mm, 4.5 mm to about 10.0 mm, 3.75 mm to about 10.0 mm, 2.25 mm to about 10,0 mm, 0.75 mm to about 10.0 mm, 0.5 mm to about 10.0 mm, 0.25 mm to about 10.0 mm, 0.15 mm to about 10.0 mm, 0.07 mm to about 10.0 mm, and 0.04 mm to about 10.0 mm.

The memory resource 204 may store instructions 225 which may be executed by the processing resource 206 to form, based on the modified data, the 3D model and the protective structure around the portion of the 3D model. In some examples, processing resource 206 may use the instructions in the modified data to print a 3D model and the protective structure. For example, the processing resource 206 may cause the additive manufacturing device to dispense printing agent or a plurality of printing agents (e.g., a fusing agent and a detailing agent) onto build material layers to form the 3D model and the protective structure around a fragile region and/or mark. In some examples, the 3D model and the protective structure may form as the printing agent is dispensed onto the build material layer and fusion energy is applied to the printing agent and build material layers. The hardware in the additive manufacturing device may dispense printing agent in a manner that causes a protective structure to surround the portion on all sides.

The protective structure may limit the amount of force exerted on the portion by partially blocking the path of the force. For example, a force that is directed at a portion may be blocked by a protective structure that surrounds the portion because the protective structure may prevent the entire force from reaching the portion. In some examples, a part of the force may reach the portion through porous openings in the protective structures. In contrast, the protective structure may not include openings and may block and prevent the entire force from reaching the portion,

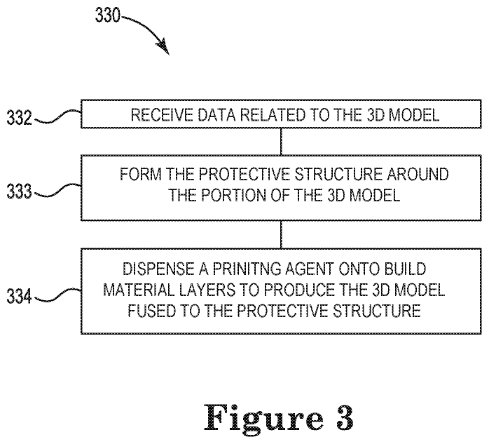

FIG. 3 illustrates an example of a method 330 consistent with the disclosure. Method 330 may be performed, for example, by a processing resource (e.g., processing resource 106, described in FIG. 1) of a system (e.g., system 100, described in FIG. 1). In some examples, the method 330 may be performed with more or less elements.

At 332, the method 330 may include receiving data related to the 3D model. In some examples, a host device (e.g., a computing device) may send data to a processing resource of a system. The data may be related to forming a 3D model. That is, the data may include instructions to form a 3D model with an additive manufacturing device. For example, the host device may send data to the system to form a 3D representation of a mouse. In some examples, the received data may include information to form a 3D model and a protective structure around a portion of the 3D model. The processing resource may use the data to cause an additive manufacturing device to produce a 3D model and the protective structure.

At 333, the method 330 may include forming the protective structure around the portion of the 3D model. In some examples, the processing resource may cause the additive manufacturing device to form a 3D model based on the instructions in the data. The 3D model may include a protective structure surrounding a portion of the 3D model. The protective structure may protect a fragile portion of the 3D model from damages during movement of the 3D model. For example, the 3D model may be a 3D representation of a mouse, as illustrated in FIG. 5. The protective structure may protect a fragile portion (e.g., a tail of a 3D representation of a mouse) from breaking during post processing of the 3D model. Similarly, the protective structure may protect the portion (e.g., authentication mark, identification mark, fiducial mark, etc.) from eroding during post processing of the 3D model. Including a protective structure around a portion of the 3D model may reduce the amount of material used to create the 3D model, compared to including a protective structure around the entire 3D model, thereby reducing the cost of the 3D model. In addition, including a protective structure around a portion of the 3D model may produce a compact 3D model, compared to including a protective structure around the entire 3D model, thereby making the 3D model easier and less expensive to ship etc.

At 334, the method 330 may include dispensing a printing agent onto build material layers to produce the 3D model fused to the protective structure. The processing resource may form the 3D model and a connected protective structure by causing the additive manufacturing device to dispense printing agent on build material layers. In some examples, the color of the 3D model and the protective structure may vary depending on the color of the printing agent dispensed. For example, the processing resource may cause the additive manufacturing device to dispense different color printing agent at different sections of the 3D model and protective structure. For instance, the additive manufacturing device may dispense different color printing agents for the 3D model and the protective structure so that the protective structure is a different color than the 3D model. This may allow the protective structure to be easily removed during removal by clearly showing which part of the object is the 3D model and which is the protective structure.

As described herein, the thickness of the protective structure can vary dependent on the amount of protection determine for the portion. For example, the processing resource may cause the additive manufacturing device to form a protective structure with a thickness ranging from about 0.1 millimeter (mm) to about 5 mm. For instance, in some examples, the protective structures may have a thickness ranging from about 0.10 mm to about 1.25 mm, 0.1 mm to about 1.5 mm, 0.1 mm to about 1.75 mm, 0.1 mm to about 2.0 mm, 0.1 mm to about 2.25 mm, 0.1 mm to about 2.5 mm, 0.1 mm to about 2.75 mm, 0.1 mm to about 3.0 mm, 0.1 mm to about 3.25 mm, 0.1 mm to about 3.5 mm, 0.1 mm to about 3.75 mm, 0.1 mm to about 4.0 mm, 0.1 mm to about 4.25 mm, 0.1 mm to about 4.5 mm, 0.1 mm to about 4.75 mm, and 0.1 mm to about 4.99 mm.

The thickness of the protective structure may be based on the amount of protection that will prevent the portion from damaging when force is exerted on the portion (e.g., forces applied to the portion during post processing). For example, the processing resource may analyze the received data to determine the amount of protection that may prevent damage to the portion and based on that determination determine a thickness of the protective structure. As used herein, a “thickness” refers to the distance through an object measured from the top to the bottom, as distinct from a width or a height of an object.

In some examples, the method 330 may include determining a portion of the 3D model in the received data to add a protective structure. For example, the received data may include information to form a 3D model without a protective structure. The processing resource may receive the data and analyze the information. The processing resource may cause the additive manufacturing device to include a protective structure around a portion and/or portions of the 3D model based on the analyzed information.

Continuing with this example, the processing resource may determine fragile regions of the 3D representation of the mouse (e.g., the 3D model) to form a protective structure around. For instance, the processing resource may determine that the arms of the mouse and/or the tail of the mouse are fragile (e.g., easily damaged when a force is exerted) and determine that the arms and/or tail should be surrounded by a protective structure. In some examples, the processing resource may include instructions in the received data to form a protective structure around an authentication mark, an identification mark (e.g., bar code, SKU, etc.), and/or a fiducial mark on the 3D representation of the mouse (e.g., the 3D model). For instance, the processing resource may identify an authentication mark, an identification mark, and/or a fiducial mark in the data received from the host device and determine that the authentication mark, identification mark, and/or fiducial mark should include a protective structure surrounding it.

In some examples, the method 330 may include modifying the received data, based on the determined portion, to generate a print data. As used here in “print data” refers to information related to the forming of a 3D model and a protective structure around portions of the 3D model, for example, the size, shape, position, orientation, color of each part of the 3D model and protective structure. In some examples, the processing resource may modify the received data to include a protective structure around the authentication mark on a 3D model, the identification marks on the 3D model, the fiducial marks on the 3D model, and/or the fragile regions of the 3D model. For instance, the received data may be changed and/or adjusted to include a protective structure. The processing resource may convert the received data to print data by adding to the received data instructions to form protective structures around portions of the 3D model. That is, the generated print data may include instructions to form a 3D model and instructions to form a protective structure around a portion of the 3D model. The processing resource may use the generate print data to produce a 3D model and the protective structure. For instance, the processing resource may use the generated print data to form a protective structure around the authentication mark on the 3D model, the identification marks on the 3D model, the fiducial marks on the 3D model, and/or the fragile regions of the 3D model.

In some examples, the method 330 may also include fusing the protective structure to the body of the 3D model. In some examples, the processing resource may cause the additive manufacturing device to form a protective structure a distance away from the portion of the 3D model. That is, the protective structure may not contact the portion of the 3D model, The protective structure may fuse to the 3D model through the body of the 3D model. However, this disclosure is not so limited. In some examples, the protective structure may contact the portion of the 3D model and the body of the 3D model. For example, as described herein, the protective structure may be positioned a range of from about 0 mm to about 10 mm away from the portion of the 3D model. That is, the protective structure may be in contact with the portion of the 3D model or positioned away from the portion of the 3D model.

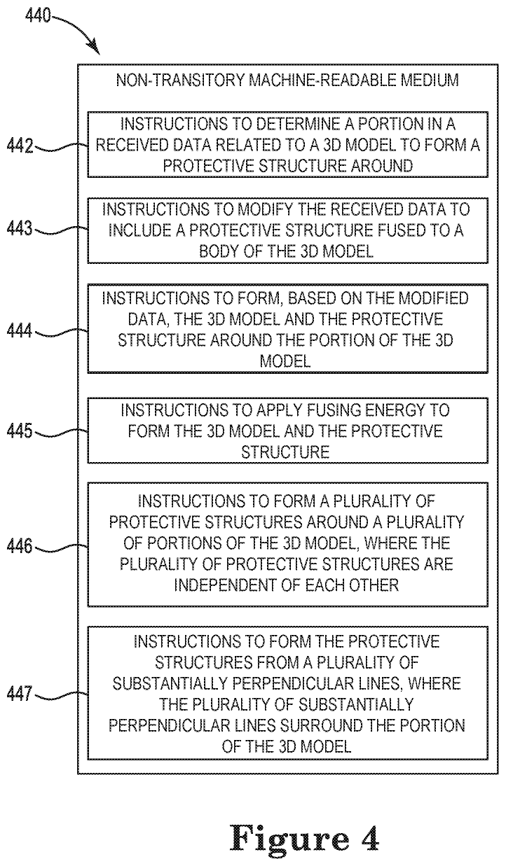

FIG. 4 illustrates an example diagram of a non-transitory machine readable medium 440 suitable with a system consistent with the disclosure. The non-transitory machine-readable medium 440 may be any type of volatile or non-volatile memory or storage, such as random-access memory (RAM), flash memory, read-only memory (ROM), storage volumes, a hard disk, or a combination thereof.

The medium 440 stores instructions 442 executable by a processing resource to determine a portion in received data related to a 3D model to form a protective structure around. The processing resource may receive a prompt to print a 3D model, The prompt may be in the form of receiving data from a host device. In some examples, the processing resource may identify a portion of the printed 3D model that may be damaged when a force is exerted on the portion, The processing resource may determine a portion of the 3D model that may be damaged during movement of the printed 3D model. For example, the processing resource may identify a portion of the printed 3D model that may be damaged during post processing, shipping, handling, or movement of the printed 3D model and may use additional support to prevent damage to the portion. The processing resource may then determine that the identified portion should include a protective structure.

The medium 440 stores instructions 443 executable by a processing resource to modify the received data to include a protective structure fused to a body of the 3D model. In some examples, the processing resource may modify the received data to include data to form a protective structure around the determined portion. The processing resource may modify the received data to cause the system to print a 3D model including a protective structure around the portion of the 3D model. The protective structure may be fused to the body of the 3D model. In some examples, fusing the protective structure to the body of the 3D model may allow access to the portion of the 3D model during post processing while providing protection to the portion of 3D model. Further, fusing a protective structure to the body of the 3D model and around a portion of the 3D model may reduce the amount of material used to create the 3D model, compared to including a protective structure around the entire 3D model, thereby reducing the cost of the 3D model while providing protection to the 3D model.

The protective structure may be positioned a distance away from the portion of the 3D model. In some examples, there may be space between the protective structure and the portion of the 3D model. For instance, the protective structure may surround the portion without coming in contact with the portion. In some examples, including space between the portion of the 3D model and the protective structure may prevent damage and/or deformation of the 3D model. For example, if the protective structure is not in contact with the portion, the portion is less likely to break during removal of the protective structure. Moreover, including space between the protective structure and the portion of the 3D model may allow for easy access to the portion during post processing, while maintaining protection of the portion.

The medium 440 stores instructions 444 executable by a processing resource to form, based on the modified data, the 3D model and the protective structure around the portion of the 3D model. In some examples, once the received data is modified to include the protective structure around the portion of the 3D model, the processing resource may carry out a print job. The processing resource may print the 3D model with protective structure surrounding a portion of the 3D model. That is, the protective structure may cover each side of the portion of the 3D model to protect the portion from damage and deformation.

The medium 440 stores instructions 445 executable by a processing resource to apply fusing energy to form the 3D model and the protective structure. In some examples, the processing resource may cause an energy source to apply fusing energy to form the 3D model and a protective structure around a portion of the 3D model. The protective structure may be fused to the body of the 3D model. However, the disclosure is not so limited. In some examples, the protective structure may be fused to a portion of the 30 model and/or the body of the 3D model. That is, the 3D model and/or the body of the 30 model may be connected to the protective structure by a fusion bond. In some examples, the fusion bond may be an under-fused bond that may be easily removed. As used herein, “under-fused bond” refers to a bond that has a low mechanical strength between the build material. However, this disclosure is not so limited. For example, the fusion bond may be a fully-fused bond or a hybrid bond. As used herein, “fully-fused bond” refers to a bond that has a high mechanical strength between the build material. As used herein, “hybrid bond” refers to a bond that has a moderate mechanical strength between the build material.

The medium 440 stores instructions 446 executable by a processing resource to form a plurality of protective structures around a plurality of portions of the 3D model, where the plurality of protective structures are independent of each other. As used herein, “independent” refers to the act of not contacting and/or depending on other structures other than the 3D model. In some examples, the processing resource may identify and/or determine a plurality of portions of a 3D model to form a protective structure around. Further, the processing resource may modify the received data to include a plurality of protective structures around a plurality of portions. In some examples, the plurality of protective structures may be independent of each other. That is, each protective structure may contact the 3D model without contacting other protective structures, For instance, each protective structure may protect a portion of the 3D model without assistance from other structure,

The medium 440 stores instructions 447 executable by a processing resource to form the protective structures from a plurality of substantially perpendicular lines, where the plurality of substantially perpendicular lines surround the portion of the 3D model, As used herein, “substantially” refers to a that characteristic does not have to be absolute but is close enough so as to achieve the characteristic. For example, “substantially perpendicular” is not limited to absolutely perpendicular. The protective structure may be made up of a plurality of substantially perpendicular lines, For instance, the protective structure may be formed by horizontal and vertical lines to create a cage-like structure. In some examples, the plurality of substantially perpendicular lines may be porous. For instance, the plurality of substantially perpendicular lines may include a plurality of openings between the horizontal and vertical lines. As used herein, “porous” refers to having minute spaces or holes through which liquid, air, and/or particles may pass.

However, this disclosure is not so limited. For example, the protective structure may be form of a plurality of solid walls without openings. That is, the portion of the 3D model may be obscured when covered by the protective structure. The protective structure may form a solid structure of build material around each side of the portion to protect the portion and prevent access to the portion. In some examples, forming a solid protective structure around a portion may prevent forces (e.g., forces applied to the portion during post processing) from reaching the portion, thereby prevent the portion from being damaged. As used herein, “solid” refers to being without internal cavity or openings.

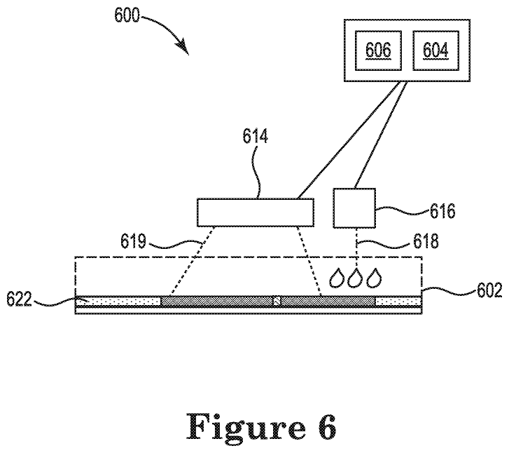

FIG. 5 illustrates an example of a three-dimensional model 508 fused to protective structures 512 consistent with the disclosure. Protective structures 512 may collectively refer to protective structures 512-1, 512-2, and 512-M. Systems (e.g., System 100 of FIG. 1 and/or System 600 of FIG. 6) described herein may produce a 3D model 508. While 3D model 508 is in the form of a mouse, other representations of 3D models are anticipated.

In some examples, a processing resource of the system may determine portions 510 of the 3D model that may use additional support to prevent damages and/or deformation after printing. Portions 510 may collectively refer to portions 510-1, 510-2, and 510-N. The determined portions 510 of the 3D model may be fragile regions (e.g., portion 510-1 in the form of a tail, portion 510-N in the form of an arm, etc.) of the 3D model that are prone to breaking and/or deforming when a force is exerted on the region. In some examples, the portions 510 may be an authentication mark, an identification mark (e.g., portion 510-2 in the form of a barcode) and/or a fiducial mark that may be eroded and/or damaged when force is exerted on the mark. For example, during post processing of a printed 3D model 508 air, liquid, and/or other particles can produce a force may be exerted on portions 510. The exerted force may damage the portions 510 of the 3D model if not minimized (e.g., a force that is less than the full force applied to the portion).

In some examples, the protective structures 512 may provide additional support to portions 510 of the 3D model 508 by fusing to the body 509 of the 3D model 508. For example, the protective structures 512 connecting to the body 509 of the 3D model 508 may provide support to the portions 510 of the 3D model 508 without contacting the portions 510. Fusing the protective structures 512 to the body 509 of the 3D model may reduce the amount of stress (e.g., force) that is applied to the portions 510 during removal of the protective structures 512 thereby preventing damage to the portions 510 of the 3D model 508.

In some examples, the protective structures 512 may be removed and/or separated from the 3D model 508 and/or body 509 of the 3D model 508. For instance, the protective structures 512 may fuse to the 3D model 508 in a manner that form a separable connection between the protective structures 512 and the 3D model 508. That is, the protective structures 512 may be separated from the 3D model 508 when a removable force is applied to the protective structures 512. As used herein, “separate” refers to the act of dividing and/or severing an object or two or more objects into two or more distinct pieces. In some examples, an under-fused bond may create a separable connection between the protective structures 512 and the 3D model 508 and/or the body 509 of the 3D model 508. However, this disclosure is not so limited. For example, a separable connection between the protective structures 512 and the 3D may be created by a fully-fused bond or a hybrid bond,

In some examples, protective structures 512 may surround portions 510 of a 3D model to minimize the amount of force that is applied to a portion 510-1, 510-2, and/or 510-N. That is, the amount of force applied to the portions 510 of the 3D model during post processing and/or movement of the 3D model may be reduced when the portions 510 are surrounded by protective structures 512, as compared to the same force applied to portions 510 without protective structures 512.

In some examples, the protective structures 512 may form a solid structure around the portions 510. For example, protective structure 512-2, represented by a box around portion 510-2, indicates a solid structure surrounding portion 510-2 on all sides. That is, air, liquid, and/or particles outside of the box representing protective structure 512-2 may not be able to contact portion 510-2 until the protective structure 512-2 is removed. Surrounding a portion 510-2 with a protective structure 512-2 that is a solid structure without openings may protect an authentication mark, an identification mark, a fiducial mark, and/or a fragile region of a 3D model from damage by preventing a damaging amount of force from reaching the portion. In some examples, the protective structures 512 may form a porous structure around the portions 510. That is, the protective structures 512 may contain openings to allow air, liquid, and/or particles to enter the structure. In some examples, surrounding a portion 510-1 and/or 510-N with a protective structure 512-1 and/or 512-M that is porous in nature may allow cleaning (e.g., cleaning during post processing) of the portion 510-1 and/or 510-N while protecting the portion 510-1 and/or 510-N from damage.

In some examples, the protective structures 512 may have a thickness ranging from about 1.0 mm to about 5 mm, including all ranges and values in between. The thickness of the protective structures 512 may be based on the amount of protection the portions 510 can use to prevent damage to the portions 510. Thus, the thickness of each protective structure 512-1, 512-2, and/or 512-M may vary. For example, the processing resource of the system may determine that the tail (e.g., portion 510-1) of a 3D model may be more fragile than the arm (e.g., portion 510-N) of the 3D model. In this instance, the processing resource may cause the additive manufacturing device to form a thicker protective structure 512-1 around the tail (e.g., portion 510-1), compared to protective structure 512-M surrounding the arm (e.g., portion 510-N). Further, the processing resource may cause the additive manufacturing device to form a thinner protective structure 512-M around the arm (e.g., portion 510-N), compared to protective structure 512-1 surrounding the tail (e.g., portion 510-1).

In some examples, the protective structures 512 may include griping and/or handling areas. The griping areas of the protective structures 512 may prevent damage to the 3D model. For instance, to reduce the amount of stress on the 3D model 508, the 3D model 508 may be held at the gripping area of the protective structures 512 rather than at the body 509 or the portion 510-1, 510-2, and/or 510-N of the 3D model 508 thereby preventing damage to the 3D model 508. In some examples, each protective structure 512-1, 512-2, and/or 512-M may include a part information tag to assist in identification of the portion 510-1, 510-2, and/or 510-N. Further, the protective structures 512 may indicate the quality of the 3D model 508. For example, the color and the geometric accuracy may be assessed through the protective structures 512.

FIG. 6 illustrates an example of a system 600 consistent with the disclosure. The system 600 is one example of an additive manufacturing device including a processing resource 606 and a memory resource 604. However, other examples of an additive manufacturing device may be used. System 600 may include analogous or similar elements as FIG. 1. For example, system 600 may include an additive manufacturing device 602, a processing resource 606, and a memory resource 604. In some examples, the memory resource 604 may store instructions from received data related to a 3D model. The processing resource 606 may modify the received data to generate print data. The print data may include instructions to form a 3D model and a connected protective structure.

For instance, the processing resources 606 may use the print data to cause the printhead 616 of the system 600 to dispense printing agent 618 onto a build material layer 622. The processing resource 606 may cause an energy source 614 to apply fusion energy, indicated by lines 619, to printing agent 618 and build material layer 622 to form the 3D model including a protective structure around a portion of the 3D model. In some examples, the energy source 614 may be selectively applied to the printing agent 618 and the build material layer 622, For example, the processing resource 606 may cause the energy source 614 to apply fusion energy 619 to the printing agent 618 and the build material layer 622 to form a fully-fused bond in one section of the 3D model and an under-fused bond in another section of the 3D model. In some examples, the thickness of the protective structure (e.g., a thickness ranging from about 0.1 mm to about 5 mm) may cause little effect on the fusion energy 619 used to form the 3D model and the protective structure, compared to forming the 3D model without the protective structure. That is, forming a 3D model including a protective structure with a thickness ranging from about 0.1 mm to about 5 mm may not cause a significant increase in the fusion energy 619 compared to forming a 3D model without the protective structure.

In some examples, based on the print data the processing resource 606 may cause the protective structure to be positioned around a portion of the 3D model. The protective structure may surround the portion of the 3D model and fuse to the portion of the 3D model and/or the body of the 3D model. For example, based on the print data, the processing resource 606 may cause the printhead 616 of the system 600 to selectively dispense printing agent 618 to form a protective structure around a portion or a plurality of portions of a 3D model. That is, based on the determined amount of protection for each portion of the 3D model, the processing resource 606 may cause the printhead 616 to selectively dispense printing agent 618 to form protective structures with varying thickness.

The figures herein follow a numbering convention in which the first digit corresponds to the drawing figure number and the remaining digits identify an element or component in the drawing. Similar elements or components between different figures may be identified by the use of similar digits. For example, 106 may reference element “06” in FIG. 1, and a similar element may be referenced as 606 in FIG. 6. As used herein, the designator “N” or “M”, particularly with respect to reference numerals in the drawings, indicates that a plurality of the particular feature so designated can be included with examples of the disclosure. The designators can represent the same or different numbers of the particular features.

Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

It should be understood that the descriptions of various examples may not be drawn to scale and thus, the descriptions may have a different size and/or configuration other than as shown therein.

What is claimed:

1. A system comprising:
an additive manufacturing device including hardware to form a three-dimensional (3D) model;
a memory resource; and
a processing resource to:
receive data related to the 3D model;
modify the data related to the 3D model to include a protective structure connected to the 3D model by a fusion bond; and
dispense, based on the modified data, a printing agent onto build material layers to produce the 3D model and the protective structure around a portion of the 3D model.

2. The system of claim 1, wherein the portion of the 3D model is an authentication mark, an identification mark, a fiducial mark, a fragile region of the 3D model, or a combination thereof.

3. The system of claim 1, wherein the fusion bond between the protective structure and the 3D model is an under-fused bond, a fully-fused bond, or a hybrid bond.

4. The system of claim 3, wherein the fusion bond creates a separable connection between the protective structure and the 3D model.

5. The system of claim , wherein the protective structure has a thickness of from about 0.1 millimeter (mm) to about 5 mm.

6. A non-transitory computer-readable data storage medium storing instructions executable by a processing resource to:
determine a portion in a received data related to a three-dimensional (3D) model to form a protective structure around;
modify the received data to include a protective structure fused to a body of the 3D model, wherein the protective structure is positioned a distance away from the portion of the 3D model; and
form, based on the modified data, the 3D model and the protective structure around the portion of the 3D model.

7. The non-transitory machine-readable medium of claim 6, including instructions to form a plurality of protective structures around a plurality of portions of the 3D model, wherein each protective structure of the plurality of protective structures are independent structures.

8. The non-transitory machine-readable medium of claim 6, wherein the protective structure around the portion of the 3D model is formed by dispensing a printing agent onto build material layers based on the modified data.

9. The non-transitory machine-readable medium of claim 8, further including instructions to apply fusing energy from an energy source to the printing agent and the build material layers to fuse the protective structure to the body of the 3D model.

10. The non-transitory machine-readable medium of claim 6, further including instructions to form the protective structure from a plurality of substantially perpendicular lines, wherein the plurality of substantially perpendicular lines surround the portion of the 3D model.

11. The non-transitory machine-readable medium of claim 6, further including instructions to form the protective structure from a plurality of solid walls, wherein the plurality of solid walls surround the portion of the 3D model.

12. A method of producing a three-dimensional (3D) model comprising:
receiving data related to the 3D model;
forming the 3D model and a protective structure around a portion of the 3D model; and
dispensing a printing agent onto build material layers to produce the 3D model fused to the protective structure.

13. The method of claim 12, further comprising:
determining the portion of the 3D model in the received data to add the protective structure around;
modifying the received data, based on the determined portion, to generate print data.

14. The method of claim 12, further comprising fusing the protective structure to a body of the 3D model.

15. The method of claim 14, further comprising positioning the protective structure the distance of from about 0.02 millimeters (mm) to about 10 mm away from the portion of the 3D model.
